(19) United States
(12) Patent Application Publication
(10) Pub. No.: US 2026/0320973 A1
(43) Pub. Date: Oct. 15, 2026

(54) GUNSHOT CLASSIFICATION USING INFRARED DATA

(71) Applicant: SHOOTER DETECTION SYSTEMS, LLC, Rowley, MA (US)

(72) Inventors: Grant Alan Hanson, Frisco, TX (US); Ronald A. Fowler, Westford, MA (US)

(21) Appl. No.: 19/644,236

(22) Filed: Apr. 10, 2026

Related U.S. Application Data
(60) Provisional application No. 63/787,010, filed on Apr. 11, 2025.

(51) Int. Cl. G06V 10/764; G06T 5/20

(52) U.S. Cl. CPC G06V 10/764; G06T 5/20; G06T 2207/10048

(57) ABSTRACT

Methods, systems, and apparatus, including computer programs encoded on computer storage media, for gunshot detection. One of the methods includes accessing infrared (IR) data captured by one or more infrared sensors using infrared band sensing; detecting a peak amplitude using the IR data; selecting, from one or more maintained classifiers and using the detected peak amplitude, a classifier for gunshot classification; and providing, using output of the selected classifier for gunshot classification, a classification of a gunshot.

### CROSS-REFERENCE TO RELATED APPLICATION

This application claims the benefit of U.S. Provisional Application No. 63/787,010, filed Apr. 11, 2025, the contents of which are incorporated by reference herein.

### TECHNICAL FIELD

This application relates generally to gunshot classification using infrared sensors.

### BACKGROUND

Various sounds and visuals can be similar to a gunshot. Because gunshots can often be incident to injury or crimes, accurate detection can aid in public safety. Non-detections can result in no response from resources, such as security systems or first responders. False positive detections can consume resources unnecessarily, which can result in delayed, or reduced, responses to actual events.

### SUMMARY

In general, one aspect of the subject matter described in this specification can be embodied in methods that include the actions of accessing infrared (IR) data captured by one or more infrared sensors using infrared band sensing; detecting a peak amplitude using the IR data; selecting, from one or more maintained classifiers and using the detected peak amplitude, a classifier for gunshot classification; and providing, using output of the selected classifier for gunshot classification, a classification of a gunshot.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. Feature 1: Actions include determining, using one or more amplitude thresholds, a comparison between the peak amplitude and the one or more amplitude thresholds, wherein selecting the classifier for gunshot classification from the one or more maintained classifiers comprises: selecting the classifier for gunshot classification using the comparison between the peak amplitude and the one or more amplitude thresholds.

Feature 2: Actions include determining a saturation level of the one or more infrared sensors using the detected peak amplitude, wherein selecting the classifier for gunshot classification from the one or more maintained classifiers comprises: selecting, using the determined saturation level, a first classifier of the one or more maintained classifiers that classifies a gunshot using a first processing pipeline different than a second processing pipeline used by a second classifier of the one or more maintained classifiers.

Feature 3: The first processing pipeline includes processing by one or more first machine learning models and the second processing pipeline includes processing by one or more second machine learning models, at least some models in the one or more first machine learning models not included in the one or more second machine learning models.

Feature 4: The first processing pipeline includes processing by a first machine learning model with a first set of training parameters and the second processing pipeline includes processing by a second, different machine learning model with a second, different set of training parameters different than the first set of training parameters. Feature 5: The first processing pipeline includes processing by two or more machine learning models and the second processing pipeline includes processing by a single machine learning model. Feature 6: Actions include generating filtered IR data by filtering the IR data captured by the one or more infrared sensors to remove one or more likely noise sources from the IR data, wherein detecting the peak amplitude using the IR data comprises: detecting the peak amplitude in the filtered IR data.

Feature 7: Generating the filtered IR data comprises: filtering the IR data using at least one of a bandpass filter, an edge pass filter, an inference filter, or a neutral density filter. Feature 8: The filtering comprises filtering out IR data that likely indicates sunlight. Feature 9: Filtering out the IR data that indicates likely sunlight comprises: filtering the IR data using a far-infrared (FIR) filter. Feature 10: Generating the filtered IR data comprises: filtering the IR data using light white noise filtering. Feature 11: Actions include providing, to the selected classifier for gunshot classification, one or more features of the filtered IR data after light white noise filtering of the IR data; and detecting, using the output of the selected classifier, a muzzle flash, wherein providing the classification of the gunshot comprises: providing an indication of the muzzle flash detection.

Feature 12: Filtering the IR data using light white noise filtering comprises: filtering the IR data captured by the one or more infrared sensors using a minimax filter. Feature 13: Actions include detecting the peak amplitude in the IR data captured by the one or more infrared sensors using infrared band sensing.

The subject matter described in this specification can be implemented in various implementations and may result in one or more of the following advantages. For example, techniques can improve the accuracy of gunshot classification by selecting, from one or more different classifiers, a specific classifier for a detected gunshot. Different gunshot signatures may be detected more accurately using one classifier compared to another. For example, in cases where an IR event, such as a gunshot or explosion, saturates a sensor, an amplitude may exceed a given threshold. Because saturation can cause sensor data to be lost, a system can select a classifier that uses raw IR data to classify a gunshot, e.g., rather than filtered IR data. In some cases, classifiers can include different input data or processing steps which can be tailored to the particular level of IR amplitude captured by IR sensors. The various different classifiers can allow a system to effectively detect different types of gunshot events.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow diagram for gunshot classification using filtered and raw data.

FIG. 2 is a flow diagram for classifier case routing.

FIG. 3 is an infographic showing gunshot classification elements.

FIG. 4 is a block diagram for a support vector machine (SVM).

FIG. 5 is a block diagram for support vector machine training.

FIG. 6 is a flow illustration for classification.

FIG. 7 is a system diagram for gunshot classification using filtered and raw data.

FIG. 8 is a flow diagram of a process for gunshot classification.

Like reference numbers and designations in the various drawings indicate like elements.

### DETAILED DESCRIPTION

Detecting gunshots within an indoor or outdoor environment can be an important part of keeping individuals safe in today’s world. It can also be a complex task to accomplish. Infrared light and explosive sounds are generated by gunshots. The light and acoustic characteristics generated by different types of weapons and ammunition can vary greatly, making identification of any particular weapon difficult. Light and sound waves can bounce off of objects, making the location of a weapon in use difficult to separate from light reflections and acoustic echoes. Light and sound waves from other sources can be mistaken for gunshots in some cases. Separating likely gunshots from these other sources can be challenging. Disclosed embodiments provide techniques for gunshot classification using filtered and raw data. The data can be collected by one or more infrared (IR) sensors. The sensors can be associated with a single-unit, position-independent, flash sensor device. Embodiments provide a processor-implemented method for gunshot classification. The method can include collecting IR information using a flash sensor device.

The one or more IR sensors can collect information using IR band sensing. Raw data collected by the sensors can be stored in the sensors. The information collected by the sensors can also be filtered to remove one or more noise sources from the raw data. Time stamps associated with the raw data can be copied to the filtered data as well. The filters can be used to remove various features, such as sunlight glints, light white noise, and other sources of IR light that can make identification of gunshot events more difficult. The filtered IR information can be analyzed to locate a region of interest within the data, including a peak amplitude. A peak amplitude can be positive or negative, as both can occur during a gunshot event. Timestamps associated with the region of interest can be captured and used to target analyses of the IR data. It can be helpful to compare the peak amplitudes identified within the filtered IR data to high and low thresholds. The comparisons can be used to classify a region of interest into a classifier case. For example, a peak that exceeds 97% of full scale can be classified as a saturated classifier case. A peak that is lower than 10% can be classified as a weak signal case. A peak that falls between a high and low threshold can be classified as an unsaturated classifier case. Grouping the regions of interest into classifier cases can be used to determine whether raw or filtered data are used to classify a peak amplitude as a gunshot or a non-gunshot event. Once a region of interest has been analyzed, the classification of a region of interest can be communicated to relevant personnel, such as law enforcement, emergency services, security systems, among others , e.g., when the classification indicates a gunshot event.

Gunshot events can develop quickly. In order to effectively respond to potential violence committed with firearms, accurate information can be detected and sent to one or more appropriate resources, such as law enforcement, emergency services, or security systems. Identifying a true gunshot event can be difficult. IR light and sound waves generated by a firearm can reflect off of walls, windows, metal, rocks, and so on, confusing sensors and humans in the area. Other light and sound sources such as cameras, fire alarms, emergency vehicles, and even doors being slammed can be confused with real gunshot events. Sensors that can collect IR light and acoustic events in real time may not be enough on their own. A system for detecting gunshots can classify information collected by sensors and analyze the data. In some cases, raw data collected by the sensors provides a source for gunshot analysis. In some cases, such as gunshot events that generate weak IR signals, filtering the raw data can be useful in sorting out light from other sources so that the analysis process can focus on possible gunshots from small caliber weapons. As gunshot events are classified and sorted out from non-gunshot events, critical information regarding the type of weapon or weapons being used, and the location of the shooter, can be sent to resources—such as responders or security systems, among others—in a timely manner.

Disclosed techniques include one or more IR sensors included in a gunshot detection and classification unit. The IR information can be collected using IR band sensing. IR data can be divided into various frequency ranges or bands, with different bands collecting varying levels of information from gunshot or non-gunshot events. A flash of light that appears similar to a gunshot to the human eye can be seen as quite different when detected by an IR sensor. The one or more IR sensors collect raw data from the environment and store it for analysis. Once collected, the IR information can be filtered to remove light noise sources, such as sunlight or IR light that has been reflected off of objects such as walls, windows, and so on. IR light sources such as camera flashes, emergency vehicle lights, and so on can also be filtered out. The filtered information can be analyzed to locate a region of interest, based on a peak IR amplitude. Peak amplitudes can be in positive or negative directions. Both peak directions can occur in a gunshot event.

Once a peak amplitude has been identified, the amplitude of the peak can be compared to one or more thresholds. Both high and low thresholds can be used to classify the region of interest. The classification can be used to determine whether raw or filtered IR data can provide greater accuracy in identifying a gunshot or non-gunshot event. The peak amplitudes can be classified as saturated, meaning that the IR sensor was fully or nearly fully saturated with IR light during the event; unsaturated, meaning that the IR sensor recorded significant data but was not at 97% or more of full scale; or a weak signal event, meaning that the peak amplitude recorded was less than 10% of full scale. Based on analysis of many previous events, raw IR data can be used to process saturated and unsaturated regions of interest, and filtered IR data can be used to process weak signal events. After a region of interest has been classified, one or more support vector machines (SVMs) can be used to process the IR information and determine whether a peak amplitude was generated by a gunshot or a non-gunshot event. Gunshot events can then be communicated to security personnel, additional gunshot detection systems, law enforcement, emergency services, and so on so that appropriate measures can be implemented. In some cases, additional information regarding the types of weapons being used, and the likely location of the shooters, can be included. This information, processed in a rapid and accurate manner, can be critical in containing the event and safely apprehending the shooters.

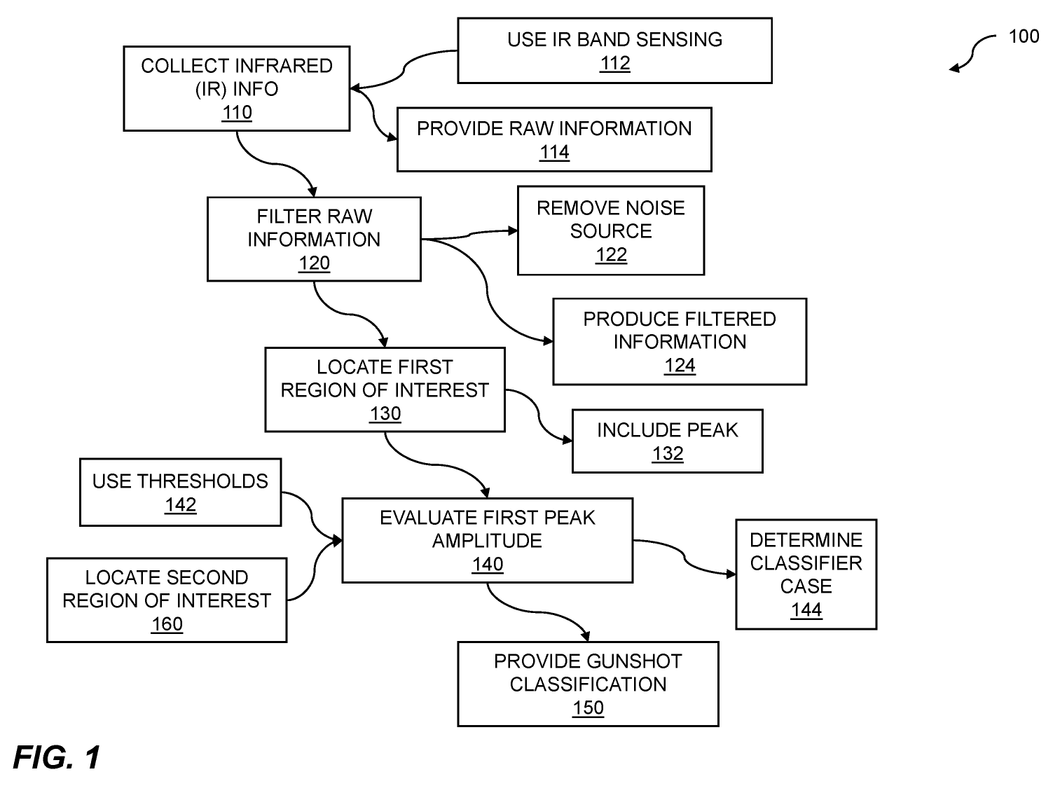

FIG. 1 is a flow diagram gunshot classification using filtered and raw data. The flow 100 includes collecting infrared (IR) information 110 using one or more infrared sensors. When a gun is fired, a bright flash of light is produced, including infrared radiation. The one or more infrared sensors can detect the light flash, even in low-light conditions or through smoke and haze. In addition, small particles of gunshot residue are produced when a gun is fired. The infrared sensors can detect these particles using infrared spectroscopy. Some of these particles are ignited as they exit the gun barrel, producing additional infrared light waves. As each infrared sensor detects light and gunshot residue events from a gunshot, the infrared information can be collected and forwarded for processing. The differences between the data collected from each of the one or more infrared sensors during the same event can be used in calculating the location and distance of the gunshot origin, as well as in classifying the event. The infrared information is collected using infrared band sensing 112 . The infrared (IR) information can include near-IR (NIR) information. The infrared sensor can sense one or more infrared bands, such as far-infrared (FIR) band light with wavelengths between 50-1000□m; mid-infrared (MIR) band light with wavelengths between 3-50□m; and so on. The IR sensor can sense near-infrared (NIR) band light with wavelengths between 0.76-3□m. The infrared information provides raw information 114 . The infrared information collected by the one or more infrared sensors can be stored “as is,” without any filtering applied to the data stream as it is captured by the one or more infrared sensors. Filtering the information from the infrared sensors can be useful in determining which elements of an information segment are important to an analysis process. In some cases, filtering can mask details of an incident that can be useful in distinguishing between sources of infrared light.

The flow 100 includes filtering the raw information 120. The filtering removes one or more noise sources 122 from the raw information. The filtering of raw infrared sensor information can include bandpass filtering, which accepts specific wavelength ranges that can include both visible and infrared light; edge pass filtering, which can be used to focus on various ranges of the infrared spectrum; interference filters, which can be used to select specific wavelengths while preventing others; neutral density filters, which can reduce the intensity of visible and infrared light waves without favoring a particular wavelength; and so on. The filtering can be performed by digital filter hardware, analog filter hardware, digital filter software, and so on. The filtering can be performed by one or more separate filters, where each of the separate filters targets a different noise source. The separate filters can be activated all the time or selectively, based on the shape, amplitude, spectral content, etc. of the collected raw infrared information. The filtering produces filtered information 124. The raw data streams from the one or more infrared sensors can be processed by one or more filters and the resulting filtered data streams can be stored for further analysis. Time stamps can be associated with the raw and filtered data streams from each IR sensor for comparison and analysis purposes.

In embodiments, the filtering comprises sunlight filtering. In embodiments, the sunlight filtering removed sunlight glints. Sunlight reflects off of surfaces such as water, glass, polished metals, and so on. The reflected sunlight can be captured by the one or more infrared sensors and can obscure features of infrared light generated by gunshot events. In embodiments, the sunlight filtering is performed using an FIR filter. A finite impulse response (FIR) filter can be used on digital signals generated by the infrared sensors as they capture infrared light events. FIR filters use a weighted sum of current and past input values. The weights are often referred to as “coefficients” or “taps.” The FIR filters can be implemented in software. When a single, brief input data stream, such as a gunshot or sunlight glint, is processed by an FIR filter, the filtered data stream settles to zero in a finite amount of time. Since there is no feedback from the output back to the input, the impulse response can be finite. This filter characteristic tends to significantly limit the amount of data related to sunlight glints or other secondary light sources in a raw infrared light data stream.

In embodiments, the filtering comprises light white noise filtering. White noise refers to unwanted, random variations within the infrared portion of the electromagnetic spectrum. White noise signals can contain equal power at one or more, or all, frequencies within a given range. Filtering white noise can be accomplished by applying software algorithms to the IR signal data stream to remove random noise components. In embodiments, the light white noise filtering enables small caliber muzzle flash detection. Light white noise filtering can allow smaller IR light events, including small caliber handgun discharges, to be detected within an infrared light data stream captured by the one or more infrared sensors. In embodiments, the light white noise filtering is performed using a minimax filter. A minimax filter can be designed to minimize the maximum possible error that can occur. Minimax filters can employ algorithms that optimize filter coefficients to minimize the maximum absolute value of an error signal. The filter design can be used to find a balance that prevents any single noise component (such as a particular glint of sunlight), from causing a large error in the data output. In embodiments, the filtering comprises a single, constrained minimax filter used for sunlight filtering, light white noise filtering, and so on.

The flow 100 includes locating a first region of interest 130, based on the filtered information. A first region of interest within the filtered IR information can be associated with an IR event that may include a gunshot event. The region of interest can be associated with changes to the IR information, where the changes can include abrupt changes. The first region of interest can be associated with a start and stop time stamp. In the flow 100, the first region of interest includes a first peak amplitude 132. The peaks can include absolute peaks or relative peaks in the IR information. The peak amplitudes can include positive peaks and negative peaks. A given region of interest can include multiple peaks, where the multiple peaks can include one or more positive peaks and one or more negative peaks.

The flow 100 includes evaluating the first peak amplitude 140 against one or more thresholds 142. For example, a high threshold can comprise 97% of full scale. A low threshold can comprise 10% of full scale. The first peak amplitude can be compared to the high and low thresholds and used to assign the peak amplitude to a classifier case or category. The evaluating determines a classifier case 144. A classifier case can be used to categorize the first peak amplitude. The classifier case can be used to determine whether a raw or filtered data stream from the one or more infrared sensors can be used to analyze the first peak amplitude. For example, a first peak amplitude that exceeds the high threshold can be classified as a saturated signal case. A first peak amplitude that falls between the high threshold percentage and the low threshold percentage can be classified as an unsaturated signal case. A first peak amplitude that is lower than the low threshold percentage can be classified as a weak signal case.

The flow 100 further comprises locating a second region of interest 160, based on the raw information, wherein the second region of interest includes a second peak amplitude. IR sensors can have limitations in their response time. The sensor design and materials used can influence how quickly the sensor can detect and convert IR radiation into an electrical signal. Signal noise can require additional time to filter out. Processing delays can also be introduced by analysis and filtering algorithms. The hardware used to manage the IR signals, store and analyze data, and so on can also introduce delays in the sensor data stream. Signal processing delays can be compensated for using predictive algorithms, delay compensation filters, time-stamping, data buffering, adaptive algorithms, and so on. Analyses of the raw data from the one or more IR sensors can result in locating a second region of interest, including a second peak amplitude. The second region of interest can be related to the same gunshot event, but with different start and stop time stamps, based on the data compensation for signal processing delays. The flow 100 can further comprise redoing the evaluating using the second peak amplitude.

The flow 100 includes providing a gunshot classification 150. The gunshot classification is based on output from a classifier selected by the classifier case. The classifier case can be used to determine whether raw or filtered data can be used to analyze the first region of interest. The classifier case can be used to select how the infrared data is analyzed, what signal features to extract, what domain features to process, and so on. The extracting of signal features from the infrared information enables information analysis and classification for IR flash events. The classification can be a binary determination of whether the infrared data indicates a gunshot event or a non-gunshot event. In some cases, additional gunshot event classifications can be associated with a long gun, a handgun, and so on. The non-gunshot classification can be associated with a lightning flash, fireworks, etc.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

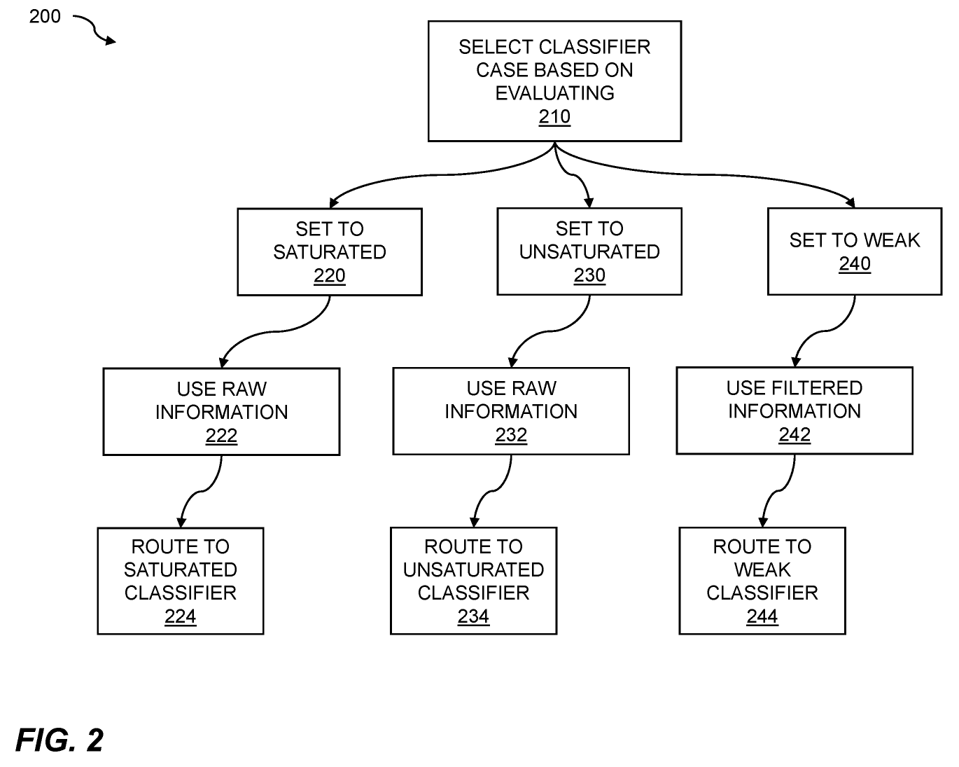

FIG. 2 is a flow diagram for classifier case routing. Possible gunshot events captured by the one or more infrared sensors can be analyzed more efficiently when separated into various groups or classifier cases. The regions of interest identified from the filtered infrared information captured by the one or more infrared sensors can be evaluated based on whether the peak amplitude included in the region of interest has surpassed a high or low threshold. The flow 200 includes evaluating the first peak amplitude against one or more thresholds, wherein the evaluating 210 determines a classifier case. The evaluating can indicate a saturated, unsaturated, or weak signal. The evaluating can include a high threshold, a low threshold, or a combination of a high and low threshold. Assigning the first peak amplitude signal to a classifier class can determine how the signal is analyzed and used to identify gunshot or non-gunshot events.

In embodiments, the evaluating indicates a saturated signal over a high threshold. Sensors such as IR sensors can operate substantially linearly over a range of IR light intensities. The IR sensor can be saturated when the intensity of the sensed IR light substantially exceeds the range of intensities associated with a substantially linear operation. Saturation can be associated with high intensity IR flash events such as gunshots, explosions, fireworks, and so on. In embodiments, a high threshold comprises a threshold of 97% of full scale. The saturation threshold can be exceeded (yes) or not exceeded (no) based on whether the first peak amplitude is greater than 97%. The flow 200 includes setting the classifier case to a saturated signal case 220. Setting the classifier case to a saturated signal case can be used to determine the IR information set used in analyzing the first region of interest. The flow 200 includes extracting a set of signal features from raw information 222 located in the first region of interest. When the one or more IR sensors are saturated, there is a potential for useful information to be lost. When a human experiences snow blindness, receptors in the eyes are unable to take in visual details for as long as they are saturated with white light reflecting off of snow and clouds along with direct sunlight in the environment. In the same way, saturated IR sensors are unable to record additional IR details within the environment for as long as the sensor is saturated. In cases where the first peak amplitude is saturated, the raw data streams captured by the one or more IR sensors can be used for gunshot classification in order to provide as many details as possible to a combined-feature support vector machine (SVM). A support vector machine can be based on a supervised learning model, where the supervised learning model can be associated with a learning algorithm. The learning algorithm can be used for data analysis, data classification, regression analysis, and so on. The SVM can be trained by applying a training dataset, where the training dataset comprises marked or labeled data. The training dataset is processed by the SVM and enables the SVM to “learn” by adjusting weights and biases associated with the SVM. The weight vector and the bias can be derived from a supervised learning training set. The learning by the SVM enables the SVM to infer a classification for data, to improve accuracy of inferences, to improve the speed at which inferences are obtained, etc. The SVM can include nonlinear processing. The processing by one or more SVMs can be determined by evaluating whether a saturation threshold was exceeded by a peak parsed from the IR information. The flow 200 includes routing the set of signal features to a saturated signal classifier 224. The combined-feature SVM can be based on a trained machine learning (ML) model. The ML model can be trained by applying labeled data which contains data such as historical data, synthetic data, and the like. The labeled data includes features such as the time domain and the frequency domain features extracted from the collected IR information. The combined-feature SVM can determine a classification which can include a gunshot event or a non-gunshot event.

In embodiments, the evaluating indicates an unsaturated signal between a high threshold and a low threshold. A first peak amplitude can be classified as unsaturated when the highest amplitude value is less than the high threshold value of 97% of full scale and greater than the low threshold value of 10% of full scale. As mentioned above and throughout, the saturation threshold can be exceeded (yes) or not exceeded (no). When the saturation threshold is not exceeded, the classifier case can be set to unsaturated. The flow 200 includes setting the classifier case to an unsaturated signal case 230. The flow 200 includes extracting a set of signal features from raw information 232 located in the first region of interest. As with the saturated classifier, the unsaturated classifier can use raw IR information captured by the one or more IR sensors to analyze the first region of interest. Using the raw IR information data can allow the one or more SVMs to extract more detailed information as compared to the filtered IR data stream. The flow 200 further comprises routing the set of signal features to an unsaturated signal classifier 234. One or more SVMs can be used to classify a local peak that does not exceed the saturation threshold. More or fewer SVMs can be included in the classification process. Each SVM can include a trained SVM. Each SVM can be based on a trained machine learning (ML) model to accomplish the classifying. The classifying can include evaluating the product of the scaled and vectorized signal features and a weight vector, with an added bias, as a positive result or a negative result. The positive result and the negative result can each indicate a classification, a classification/not classification, and so on. The result can include a value greater than zero (positive) or a value less than zero (negative). Progression from one SVM to another SVM can be based on a positive value or outcome. Progression to an additional stage can be based on a binary classification outcome at a current stage. The binary outcome can include the positive or negative outcome, a “yes” or “no,” etc. The binary classification outcome can include a maybe/no decision. The result can be a classification of a first region of interest as a gunshot event or a non-gunshot event. The gunshot flash classification can be associated with a long gun, a handgun, and so on. The non-gunshot classification can be associated with a lightning flash, fireworks, etc.

In embodiments, the evaluating indicates a weak signal under a low threshold. IR light events can be generated in many different ways, including natural events like lightning, and manufactured causes such as fireworks, camera flashes, gunshots, and so on. Some IR light events can be extremely low in amplitude, making them more difficult to detect with an IR sensor. Relatively small IR light events that occur near the far limits of an IR sensor range can result in weak signals reaching the sensor. There are several small caliber handguns that can produce small muzzle flashes, such as a .22 LR, .32 ACP, and .380 ACP. Other small handguns can include flash suppression features or can use ammunition designed for low-flash performance. Depending on environmental conditions, these weapons can produce weak IR signals when fired within the range of the one or more IR sensors. In embodiments, a low threshold comprises a threshold of 10% of full scale. The low threshold can be exceeded (yes) or not exceeded (no) based on whether the first peak amplitude is less than 10%. The flow 200 can further comprise setting the classifier case to a weak signal case 240. Setting the classifier case to a weak signal case can be used to determine the IR information set used in analyzing the first region of interest. The flow 200 can further comprise extracting a set of signal features from the filtered information 242 located in the first region of interest. Filtering out IR signals that can compete or “drown out” weak first peak amplitude signals can be useful in analyzing whether the peak amplitude is or is not a gunshot event. In cases where the first peak amplitude is weak, the filtered IR data streams can be used for gunshot classification in order to provide as many details as possible to a combined-feature support vector machine (SVM). The flow 200 can further comprise routing the set of signal features to a weak signal classifier 244. The support vector machine can be trained based on historical sensor data. As with the saturated and unsaturated classifiers, the result can be a classification of a first region of interest as a gunshot event or a non-gunshot event. The gunshot flash classification can be associated with a long gun, a small handgun, and so on. The non-gunshot classification can be associated with one or more lights being turned on and off, a flash of sunlight off of a shiny surface such as a mirror or vehicle window, etc.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

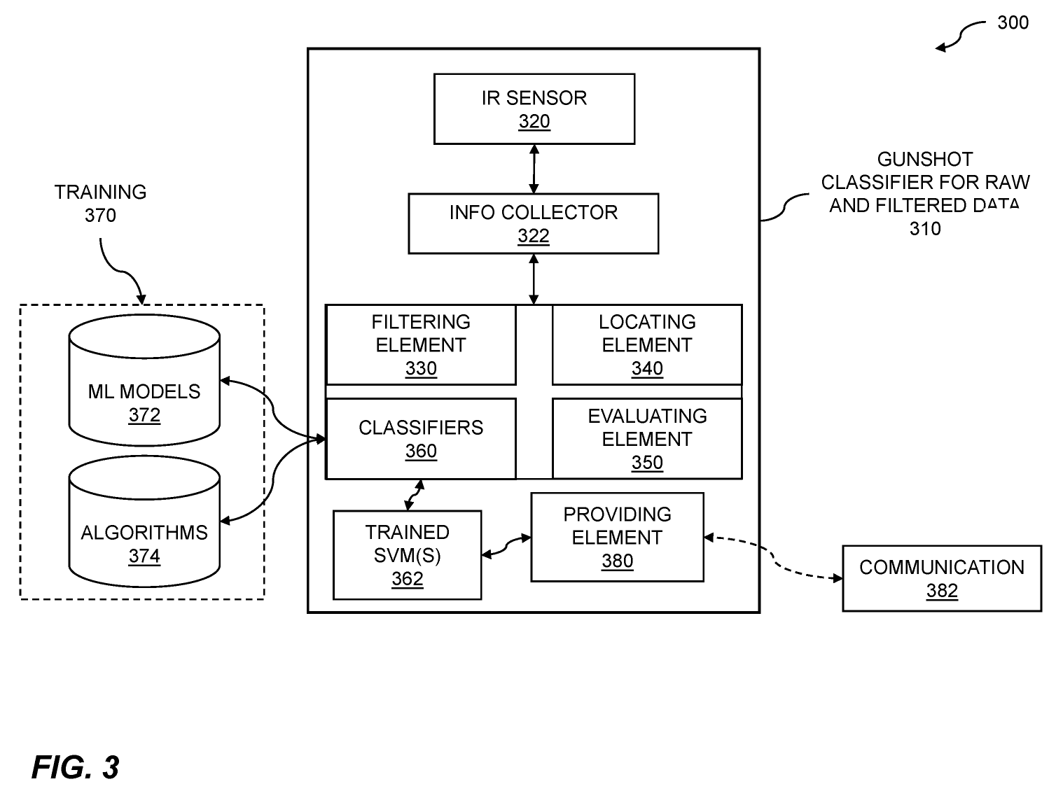

FIG. 3 is an infographic showing gunshot classification elements. The infrared flash detector can be used to classify various types of infrared flash events such as flash events associated with gunshots, strobes, lightning flashes, reflections of sunlight off of surfaces, and so on. The infrared flash classification can be based on time domain features and frequency domain features associated with infrared flash signal features. The infrared flash signal features can be associated with infrared information collected using one or more infrared sensors. The one or more infrared sensors can be associated with an infrared sensor device. The infrared sensor device can include a single unit infrared flash detector that can be placed at an indoor location, an outdoor location, in public spaces, etc. The indoor location can include a school, hospital, enterprise, and the like. The outdoor location can include a public park, a courtyard, a road intersection, and so on. One or more infrared sensors within the infrared flash detector can be given aegis by a glass coverlet. The outdoor flash detector enables outdoor flash detection and enables classification of outdoor infrared flash events such as gunshots, lightning, strobes, etc. The infrared flash detector device enables flash classification using machine learning. Infrared information is collected using one or more infrared sensors, wherein the infrared information is collected using infrared band sensing. The infrared information is parsed, wherein the parsing determines at least one local peak in the infrared information. Signal features surrounding the at least one local peak are extracted. An infrared flash is classified, based on the signal features, wherein the classifying is performed by one or more machine learning models.

The infographic 300 can include a gunshot classifier for raw and filtered data 310 . The gunshot classifier can be enclosed in a housing which can contain components associated with the infrared flash sensor device. The housing can comprise various materials and can provide protection against environmental hazards such as dust, dirt, precipitation, extreme temperatures, and the like. The housing can further provide protection against vandalism or tampering. The gunshot classifier can be in communication with at least one infrared (IR) sensor 320 . The IR sensor can be used to detect IR light in various IR bands. In embodiments, the IR sensor can detect IR light within the near-infrared (NIR) light band. The near-infrared (NIR) sensor can collect near-infrared information within an environment such as an indoor environment or an outdoor environment. The near-infrared sensor can detect near-infrared band light with wavelengths between 0.78□m and 3□m. The gunshot classifier can include two or more near-infrared sensors, where the two or more near-infrared sensors can be oriented to cover different fields of view, overlapping fields of view, redundant fields of view, and so on. The near-infrared sensor can sense possible gunshot occurrences such as muzzle flashes.

Communications between the one or more IR sensors can be accomplished using an information collector 322. The information collector can set up and configure the one or more infrared sensors, evaluate the sensors, provide power control to the sensors, operate the sensors such that NIR information can be collected from the sensors, and so on. The information collector can provide offsets, normalization factors, and the like that may be expected in some cases by the IR sensor. The information collector can collect IR information continuously, periodically, based on a potential gunshot event, etc. The information collector can be coupled to other elements included in the gunshot classifier, including the filtering element 330, locating element 340, classifiers 360, and evaluating element 350.

The gunshot classifier can include a filtering element 330. The filtering element can be used to filter out periodic IR pulses that can result from a flashing fire alarm, a security breach alert, a lockdown strobe light, etc. The filtering element can also be used for filtering out the IR noise of higher power bulbs, halogen lightbulbs, fluorescent lightbulbs, and so on. The IR noise that is filtered out can be related to powerline frequencies, such 50 Hz or 60 Hz; to a multiple of powerline frequencies, such as 120 Hz; or to some other periodic IR stimulation frequency. The filtering of infrared sensor information can include bandpass filtering, which accepts specific wavelength ranges that can include both visible and infrared light; edge pass filtering, which can be used to focus on various ranges of the infrared spectrum; interference filters, which can be used to select specific wavelengths while preventing others; neutral density filters, which can reduce the intensity of visible and infrared light waves without favoring a particular wavelength; and so on. The filtering can include sunlight filtering and light white noise filtering.

The gunshot classifier can include a locating element 340. The locating element can analyze raw and/or filtered IR data to identify one or more regions of interest which include a peak amplitude. The peak can include a peak with the greatest magnitude or amplitude within the IR information, a relative peak, a peak within a time window, and the like. The peak can include a positive peak or a negative peak. The peak can include a compound peak. One or more peak amplitudes can be associated with one or more IR events. The peak amplitudes can include positive peaks and negative peaks. The positive peaks and the negative peaks can be associated with the IR information, and if collected, the acoustic information, or both the IR information and the acoustic information. The peaks can be associated with muzzle flashes, muzzle blasts, high pressure level sounds, and the like. Embodiments further include buffering the infrared information. Time stamps within the IR data can be used to identify the beginning and end of a region of interest that includes a peak amplitude. The region of interest demarcation can be used to identify areas within the IR sensor data for additional analysis, filtering, classification, and so on.

The gunshot classifier can include classifiers 360. The classifiers can classify an infrared flash, based on the signal features. The signal features can include one or more of the time domain features, frequency domain features, energy features, rising and falling slope features, etc. The classifying can be applied to the raw sensor data, to filtered sensor data, and so on. In the gunshot classifier, the classifying can be performed by one or more machine learning models 372. The machine learning (ML) models can be based on one or more machine learning modeling techniques. The machine learning models can be based on supervised learning techniques. Supervised learning techniques can be used to train a machine learning model “by example.” Test data can be used to train 370 an ML model, where the test data can be labeled by expected outputs with respect to the data. In a usage example, a dataset containing IR flash data can be labeled for IR flash events associated with gunshot events and IR flash events that are unrelated to gunshot events. The training the ML model can include adjusting the ML model to identify gunshot events and to reject non-gunshot events. Other ML model training techniques can include semi-supervised training, unsupervised training, reinforcement training, and so on. Semi-supervised training can be based on providing labeled and unlabeled data to train the ML model. Unsupervised training can be based on the ML model being used to identify patterns or clusters within the data. Reinforcement training can be based on providing rules to the ML model and enabling the ML model to experiment with model configurations in an attempt to find an optimum or local optimum solution.

In the gunshot classifier, the classifying can be based on one or more machine learning algorithms 374. The machine learning algorithms can be used to adjust weights and biases, and so on, associated with one or more machine learning models. The machine learning algorithms that can be applied to ML model training can include naïve Bayes classifier, linear regression, nonlinear regression, K means cluster algorithm, decision trees, and so on. The ML learning models can be executed using a network associated with the gunshot classifier. A network for executing an ML model can include an artificial neural network (ANN). Another technique for implementing ML models can be based on support vector machines (SVMs). The analysis device can further include a trained support vector machine (SVM) 362. The SVM is trained using a dataset that has been marked or labeled. The marks or labels associated with the dataset indicate desired inferences that the SVM is expected to make when processing new data (e.g., data other than the training data). The classifying can be performed by the trained support vector machine. The classifying can be based on a positive or negative result, where a positive result can be associated with a first category such as a weapons category, and a negative result can be associated with a second category. The first classification can be a gunshot flash classification, and the second classification can be a non-gunshot classification.

The gunshot classifier can include an evaluating element 350. The evaluating element can evaluate the peak elements included in the one or more regions of interest against one or more thresholds. In embodiments, a high peak threshold can comprise a threshold of 97% of full scale. A low peak threshold can comprise a threshold of 10% of full scale. The evaluating can be performed on filtered data collected by the one or more IR sensors. In some embodiments, the evaluating can be performed on raw data collected by the one or more IR sensors. The evaluating can determine a classifier case. A classifier case can be used to categorize a peak amplitude included in a region of interest. The classifier case can be used to determine whether a raw or filtered data stream from the one or more infrared sensors can be used to analyze a peak amplitude. For example, a first peak amplitude that exceeds the high threshold can be classified as a saturated signal case. A first peak amplitude that falls between the high threshold percentage and the low threshold percentage can be classified as an unsaturated signal case. A first peak amplitude that is lower than the low threshold percentage can be classified as a weak signal case.

The gunshot classifier can include a providing element 380. The providing element can gather information from one or more classifiers to provide a gunshot classification. The gunshot classification is based on output from a classifier selected by the classifier case. The classifiers can include one or more trained SVMs 362 to accomplish the gunshot classification. The classifier case can be used to determine whether raw or filtered data can be used to analyze the first region of interest. The classifier case can be used to select how the infrared data is analyzed, what signal features to extract, what domain features to process, and so on. The extracting of signal features from the infrared information enables information analysis and classification for IR flash events. The classification can be a binary determination of whether the infrared data indicates a gunshot event or a non-gunshot event. In some cases, additional gunshot event classifications can be associated with a long gun, a handgun, and so on. The non-gunshot classification can be associated with a lightning flash, fireworks, etc.

The infographic 300 can include a communication device 382. The communication device can include a wired interface, a hybrid interface (e.g., wired and wireless), a wireless interface, and so on. The wireless interface can enable cable-free communication to one or more additional gunshot classifiers, to one or more additional gunshot detection systems, to communication equipment, to a network such as a computer network or a cellular telephony network, and so on. The wireless interface can communicate using one or more wireless communication techniques including Wi-Fi, Bluetooth, Zigbee, near-field communication (NFC), and so on. The wireless interface may use a low power communication technique to reduce power consumption, to evade detection, to avoid interference with other wireless systems and services, etc. The cable-free communication to a network can include one or more power communication relay devices. A power communication relay device can detect a signal and retransmit the signal. The communication relay devices, or “repeaters,” can repeat a signal from the wireless interface to extend range, to transfer a signal from one wireless interface to another wireless interface, to convert the wireless signal to a wired signal, and the like.

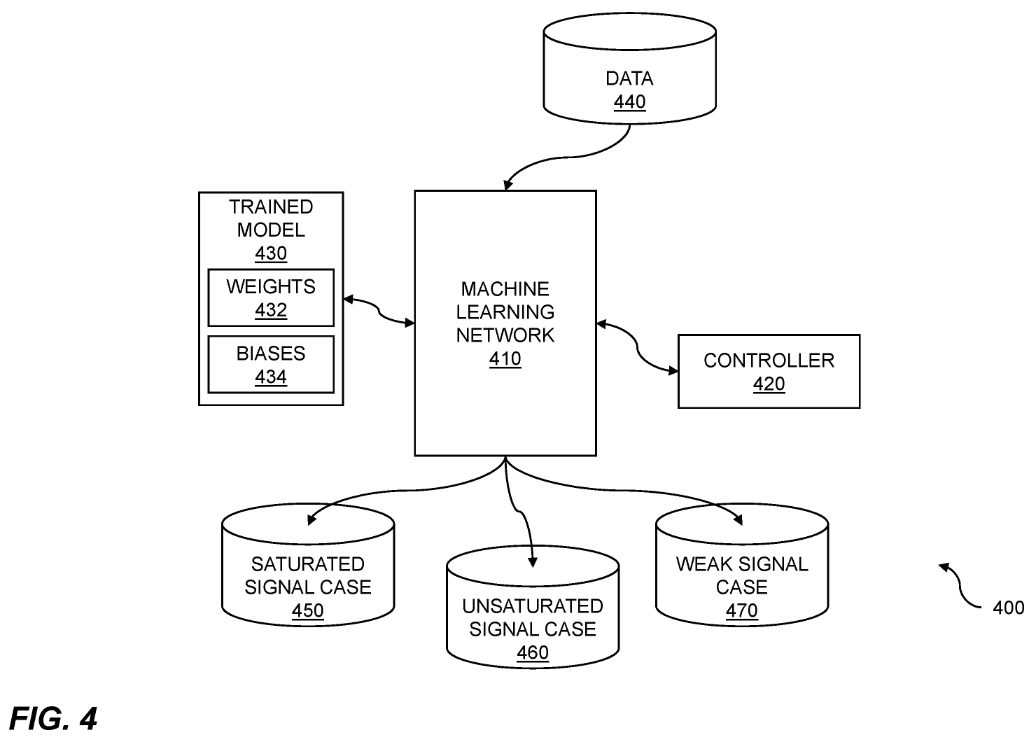

FIG. 4 is a block diagram for a support vector machine (SVM). A support vector machine (SVM) can be based on an algorithm, such as a machine learning (ML) algorithm, which enables a machine learning technique. The ML technique is enabled by the SVM. The SVM can include a class of kernel machine, where a kernel machine can be used for pattern analysis. The SVM can be used to process data such as NIR data in order to identify patterns, trends, clusters, and the like within the data. The SVM can be used to classify the data. Classifying the data can include assigning data to one of two classes based on inferences drawn on the data. The inferences that are drawn are based on a machine learning algorithm that has been trained. The data can be identified by the SVM to be a member of one class such as a first class, or a member of another class such as a second class. The SVM can be executed on one or more processors, a network such as a neural network, and so on. The support vector machine enables flash classification using machine learning. Infrared information is collected using one or more infrared sensors, wherein the infrared information is collected using infrared band sensing. The infrared information is parsed, wherein the parsing determines at least one local peak in the infrared information. Signal features surrounding the at least one local peak are extracted. An infrared flash is classified, based on the signal features, wherein the classifying is performed by one or more machine learning models.

The block diagram 400 can include a machine learning (ML) network. The ML network 410 can include one or more processors. The processors can be configured in a network such as a neural network. The ML network can be implemented using code. The code can include code generated by a high-level compiler such as a C, C++, or Python compiler; a special-purpose compiler; etc. The code can further include an assembly code or similar low-level code. The block diagram 400 can include a controller 420. The controller can be used to obtain and direct data to the ML network, to select and load a trained ML model, and the like. The controller can be used to enable further learning by the trained learning model. The block diagram 400 can include a trained ML model 430. The trained ML model can be based on an algorithm, where the algorithm has been trained by providing a training dataset for processing by the algorithm. The training dataset comprises data that has been marked or labeled to indicate one or more expected inferences about that data. The training dataset is used to adjust parameters such as a weights and biases associated with the trained ML model. The ML model can further include weights 432 and biases 434. The weights and the biases enable the trained ML model to make desired inferences about data. The inferences can be based on classifications. The classifications can include temporal and spectral features associated with the infrared information. The time domain features can include positive peak amplitude, negative peak amplitude that follows an initial positive peak, pre-peak infrared level, and a ratio of a positive peak amplitude to a negative peak amplitude that follows an initial positive peak. Frequency domain features can include a Fast Fourier Transform of samples surrounding a local peak, logarithms of a Fast Fourier Transform of samples surrounding a local peak, and so on.

The trained ML model can be executed on the ML network in order to process data. The block diagram 400 includes data 440. The data includes the collected infrared information. The trained ML model can be used to process raw or filtered infrared information. The processing can determine a classifier case. A classifier case can be used to categorize a peak amplitude. The classifier case can be used to determine whether a raw or filtered data stream from the one or more infrared sensors can be used to analyze the peak amplitude. A peak amplitude that exceeds a high threshold can be classified as a saturated signal case 450. A peak amplitude that falls between the high threshold percentage and the low threshold percentage can be classified as an unsaturated signal case 460. A peak amplitude that is lower than the low threshold percentage can be classified as a weak signal case 470.

The block diagram 400 can include setting the classifier case to a saturated signal case 450. Setting the classifier case to a saturated signal case can be used to determine the IR information set used in analyzing the first region of interest. The block diagram 400 can include extracting a set of signal features from raw IR sensor information located in the first region of interest. When the one or more IR sensors are saturated, there is a potential for useful information to be lost. Saturated IR sensors are unable to record additional IR details within the environment for as long as the sensor is saturated. In cases where the first peak amplitude is saturated, the raw data streams captured by the one or more IR sensors can be used for gunshot classification in order to provide as many details as possible to a combined-feature support vector machine (SVM). The block diagram 400 can include routing the set of signal features to a saturated signal classifier. The combined-feature SVM can be based on a trained machine learning (ML) model. The ML model can be trained by applying labeled data which contains data such as historical data, synthetic data, and the like. The labeled data includes features such as the time domain and the frequency domain features extracted from the collected IR information. The combined-feature SVM can determine a classification which can include a gunshot event or a non-gunshot event.

The block diagram 400 can include setting the classifier case to an unsaturated signal case 460. The block diagram 400 can also include extracting a set of signal features from raw information located in the first region of interest. As with the saturated classifier, the unsaturated classifier can use raw IR information captured by the one or more IR sensors to analyze the first region of interest. Using the raw IR information data can allow the one or more SVMs to extract more detailed information as compared to the filtered IR data stream. The block diagram 400 can include routing the set of signal features to an unsaturated signal classifier. One or more SVMs can be used to classify a local peak that does not exceed the saturation threshold. More or fewer SVMs can be included in the classification process. Each SVM can include a trained SVM. Each SVM can be based on a trained machine learning (ML) model to accomplish the classifying. The classifying can include evaluating the product of the scaled and vectorized signal features and a weight vector, with an added bias, as a positive result or a negative result. The positive result and the negative result can each indicate a classification, a classification/not classification, and so on. The result can include a value greater than zero (positive) or a value less than zero (negative). Progression from one SVM to another SVM can be based on a positive value or outcome. Progression to an additional stage can be based on a binary classification outcome at a current stage. The binary outcome can include the positive or negative outcome, a “yes” or “no,” etc. The binary classification outcome can include a maybe/no decision. The result can be a classification of a first region of interest as a gunshot event or a non-gunshot event. The gunshot flash classification can be associated with a long gun, a handgun, and so on. The non-gunshot classification can be associated with a lightning flash, fireworks, etc.

The block diagram 400 can further comprise setting the classifier case to a weak signal case 470. Setting the classifier case to a weak signal case can be used to determine the IR information set used in analyzing the first region of interest. The block diagram 400 can include extracting a set of signal features from filtered IR sensor information located in the first region of interest. In cases where the first peak amplitude is weak, the filtered IR data streams can be used for gunshot classification in order to provide as many details as possible to a combined-feature support vector machine (SVM). The block diagram 400 can include routing the set of signal features to a weak signal classifier. The support vector machine can be trained based on historical sensor data. As with the saturated and unsaturated classifiers, the result can be a classification of a first region of interest as a gunshot event or a non-gunshot event. The gunshot flash classification can be associated with a long gun, a small handgun, and so on. The non-gunshot classification can be associated with one or more lights being turned on and off, a flash of sunlight off of a shiny surface such as a mirror or vehicle window, etc.

In the saturated signal case 450, the unsaturated signal case 460, and the weak signal case 470, the processing of the data can include classifying the data into categories. The classifying the data into the categories can include a presence or absence of an infrared flash event, a strobe associated with an alarm, a lightning flash, a reflection off a vehicle, etc. The classification can be based on a positive result or a negative result of the classifying. As mentioned above, the classifying can include evaluating the product of scaled and vectorized signal features and a weight vector, with an added bias, as a positive result or a negative result. The weight vector and the added bias can be obtained from a variety of sources. The weight vector and the bias can be uploaded by a user, downloaded from a library, and so on. The weight vector 432 and the added bias 434 can be derived. The weight vector and the bias can be derived from a supervised learning training set. The positive result and the negative result can be used for a variety of purposes. A positive result can indicate a first classification, and a negative result can indicate a second classification. The first and second classifications can include a presence or confirmation of an event (e.g., a positive result), or an absence of an event (e.g., a negative result). The positive result and the negative result can be used to differentiate between types or sources of infrared flashes. The first classification can be a gunshot flash classification, and the second classification can be a non-gunshot classification. The first classification can include a firearm classification such as a long gun classification or a handgun classification. The second classification can include a different infrared flash classification such as a strobe or lightning event. The long gun can include a bolt-action, semiautomatic, or automatic weapon, etc. The handgun can include a revolver or semiautomatic weapon, and the like.

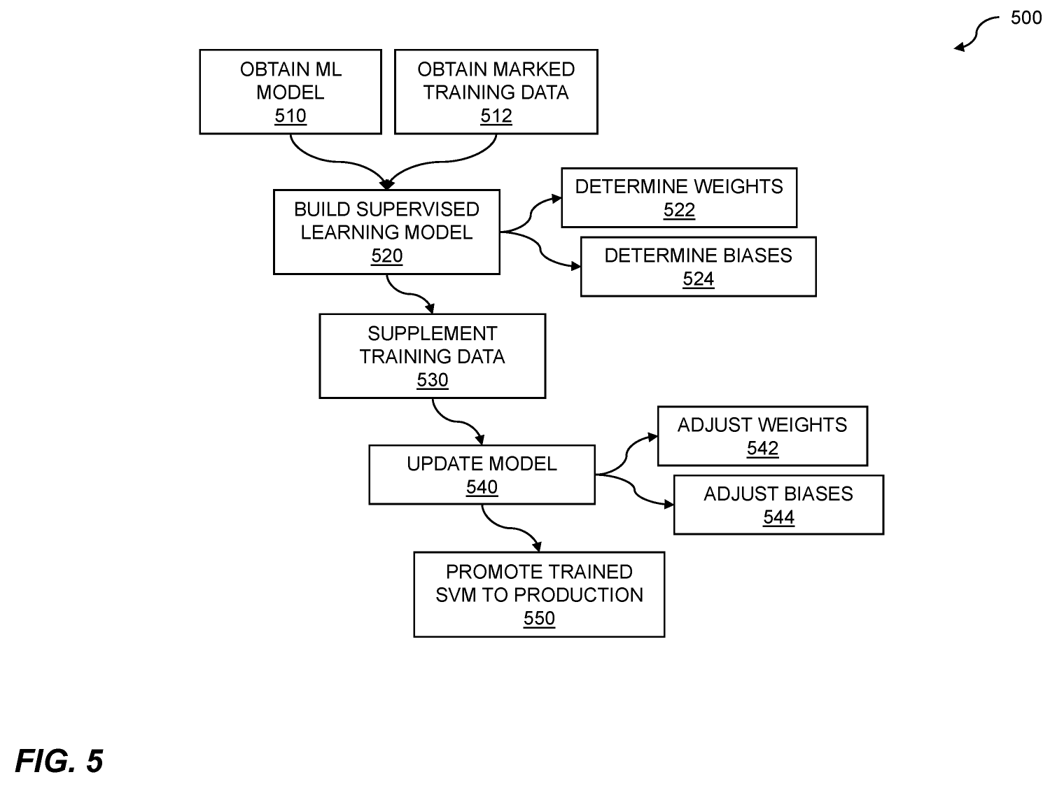

FIG. 5 is a block diagram for support vector machine training. Discussed previously, a support vector machine (SVM) can be based on a machine learning algorithm that can be used for pattern analysis of data. The pattern analysis can include classification of the data into one of two classes. In order for the SVM to accomplish the classification of the data, the SVM can be trained. The training can be based on providing a training dataset, where the training dataset includes “labeled” or “tagged” data. A label associated with the data can include a classification. The training data is applied to the SVM, and weights and biases associated with the SVM can be adjusted. The adjustment of the weights and biases associated with the SVM can continue until the SVM correctly classifies the training data as correctly being a member of one of two classes. The adjustments can also accomplish faster convergence of the SVM to determine the correct classification of the data. The training the SVM enables flash classification using machine learning. Infrared information is collected using one or more infrared sensors, wherein the infrared information is collected using infrared band sensing. The infrared information is parsed, wherein the parsing determines at least one local peak in the infrared information. Signal features surrounding the at least one local peak are extracted. An infrared flash is classified, based on the signal features, wherein the classifying is performed by one or more machine learning models.

The flow 500 includes obtaining 510 a machine learning (ML) model. The ML model can be uploaded by a user, downloaded from a repository such as an online library or cloud storage, and so on. The ML model can include a general-purpose model, a previously trained model, and the like. The model can be associated with the Kernel Method for machine learning. The algorithm associated with the Kernel Method can be used for pattern analysis. The flow 500 can include obtaining 512 marked or labeled training data. The marked training data can include data that has been analyzed by human experts, a previously trained ML model, and so on. In a usage example, a collection of infrared flash information data has been analyzed by human experts. The human experts have classified some of the infrared flash information as containing gunshot flash events, and other sound recordings as not containing gunshot flash events. The latter information can include flashes of sunlight such as reflections off of shiny surfaces, fireworks, strobes, etc. The marked training data can be applied to the ML algorithm in order to train or tune the algorithm to correctly classify gunshot events within the marked infrared information.

The flow 500 includes building 520 a supervised learning model. Supervised learning is based on providing a training dataset that has been marked or labeled. The labeling, which can be accomplished by human experts who have examined the dataset, indicates an inference that the supervised learning model is expected to make based on the dataset. Supervised learning of the SVM is based on applying the marked training data to the ML algorithm. The training accomplishes adjustments to the algorithm so that the algorithm can correctly classify the training data. The classifying can include detecting the presence or absence of a flash such as infrared flash. The adjustments that can be made to the ML algorithm for training purposes can include adjusting weights, applying a bias, and so on. The flow 500 can include determining weights 522 for the ML model. The adjusting of the weights can include varying a weight for each computation associated with the SVM. The adjusting the weights can include an iterative technique where the adjusting the weights can continue throughout the processing of the training dataset. The flow 500 can further include determining biases 524. The bias can include the distance between a hyperplane separating clusters of points associated with classifications determined by an SVM.

The flow 500 includes supplementing 530 the training data. The marked training data can be supplemented with additional marked training data. The additional marked training data can include data generated by human experts. The additional data can include historical data. The additional marked training data can include synthetic data. The synthetic data can be generated using a generative technique, where the generative technique generates and marks data that can be substantially similar to the marked data generated by the human experts. The generative technique can generate more marked data faster than can the human experts. The flow 500 include updating 540 the supervised learning model. The supplemental, marked training data can be applied to the supervised ML model. The supplemental training can be used to further adjust the ML weights 542, and to further adjust the ML biases 544. The updating of the learning model can continue while the supplemental training data is available, until the ML model meets or exceeds a classification accuracy threshold, while convergence speed increases, and the like. The flow 500 includes promoting the trained SVM to production 550. The promoting can indicate that the ML model is ready for processing of “production” or real data. In embodiments, the trained SVM can continue to learn based on the application of production data. The continued learning can be based on a semi-supervised training technique, an unsupervised training technique, etc.

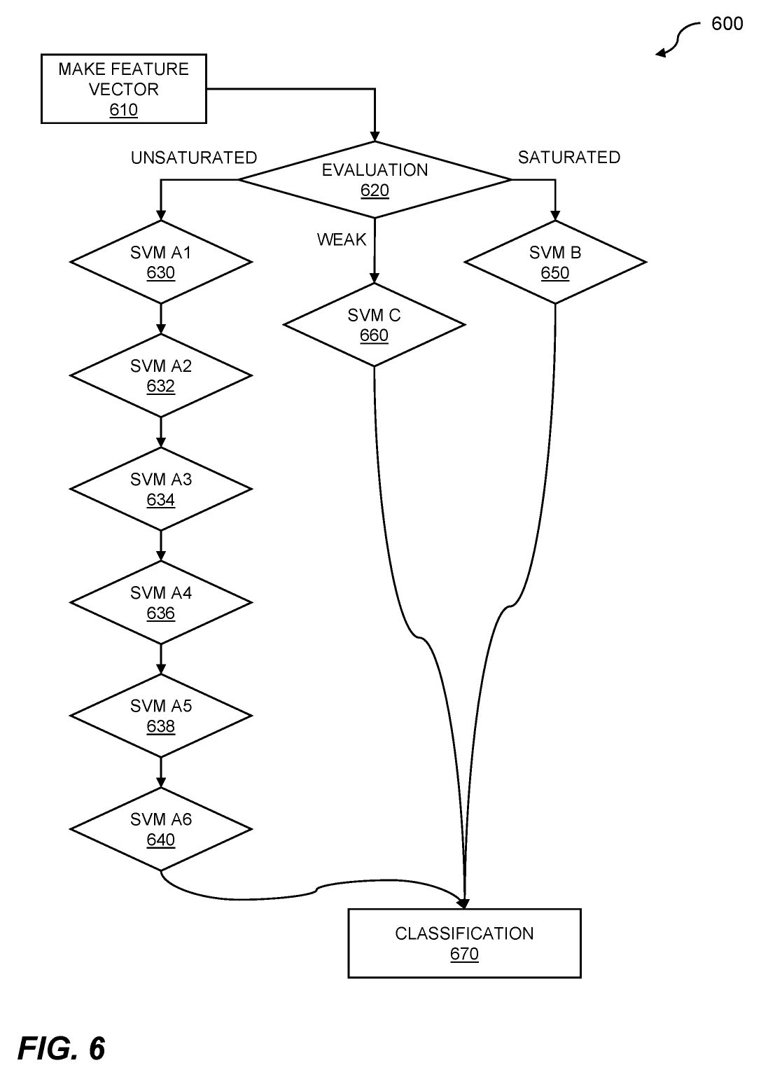

FIG. 6 is a flow illustration for classification. Various events such as infrared (IR) flash events can be classified. Discussed previously and throughout, the IR events can be associated with lightning flashes, fireworks, strobes such as fire alarm strobes, and so on. The IR events can include flashes of sunlight such as flashes resulting from the sunlight reflecting off of water, vehicle windshields, building windows, mirrors, and other shiny surfaces. The IR flash events can be associated with gunshot events. The classifying can be used to determine a likelihood that an IR flash event is associated with a particular class. The classifying process can be separated into saturated, unsaturated, and weak classifier cases. The classifier cases can be used to determine whether raw or filtered IR sensor data is used in the classification analysis. In a usage example, an IR flash event is detected. By processing data associated with the flash event, a determination can be made as to whether the flash event may have been caused by a gunshot event or not. If not, then further classifying can be performed in order to determine another possible cause of the event. Flash classification of an IR flash event is enabled using machine learning. Infrared information is obtained using one or more infrared sensors, wherein the infrared information is collected using infrared band sensing. The infrared information is parsed, wherein the parsing determines at least one local peak in the infrared information. Signal features surrounding the at least one local peak are extracted. An infrared flash is classified, based on the signal features, wherein the classifying is performed by one or more machine learning models.

Discussed previously, signal features can be extracted from collected infrared information. The collected infrared information can be raw or filtered information. The signal features surrounding at least one local peak can be extracted. The signal features can include time domain features such as positive peak amplitude, negative peak amplitude that follows an initial positive peak, pre-peak infrared level, and a ratio of a positive peak amplitude to a negative peak amplitude that follows an initial positive peak. The time domain features can include features associated with the peak such as peak width at percentages of a positive peak amplitude such as at 25%, 50%, 65%, and/or 97% values. The time domain features energy values associated with the peak. The time domain features associated with energy include peak pulse energy, pre-peak energy, post-peak energy, and/or the ratio of post-peak energy to pre-peak energy. The time domain features can further include rising and falling slopes, rising and falling edge counts, and so on. The features can further include frequency domain features. The frequency domain features can include a Fast Fourier Transform (FFT) of samples surrounding a local peak. The frequency domain features can also include logarithms of a Fast Fourier Transform of samples surrounding a local peak. An FFT can be performed on samples surrounding the peak in batches of up to 25ms. Using a longer sampling time batch, such as 100ms, can enable the testing of feature statistics over time. The classifying can be based on the time domain features, the frequency domain features, or both.

The illustration 600 shows classification of the signal features. The signal features can be formatted in order to enable processing of the signal features for classification. Further embodiments include scaling and vectorizing the signal features 610. The scaling and vectorizing the signal features can be accomplished using an analysis device, a processing device associated with one or more IR sensors, an external processing device, and so on. The classifying the signal features can include comparing a peak such as a local peak to one or more thresholds. Embodiments include evaluating 620 the at least one local peak with a high and/or low threshold. Recall that sensors such as IR sensors can operate substantially linearly over a range of IR light intensities. The IR sensor can saturate when the intensity of the sensed IR light substantially exceeds the range of intensities associated with a substantially linear operation. Saturation can be associated with high intensity IR flash events such as gunshots, explosions, fireworks, and so on. In embodiments, the saturation threshold can be 97% of full scale. In embodiments, the weak signal threshold can be 10% of full scale.

In the evaluation of the peak amplitude, the saturation threshold can be exceeded (yes) or not exceeded (no). When the saturation threshold is not exceeded, the embodiments include processing the signal features using one or more single-feature support vector machine stages. The processing of the signal features can be accomplished using raw IR sensor data. The raw IR sensor data can include a peak amplitude included in a region of interest within the sensor data. In the illustration 600, the one or more SVMs that can be used to classify a local peak that does not exceed the saturation threshold can include SVM A1630, SVM A2632, SVM A3634, SVM A4636, SVM A5638, SVM A6640. More or fewer SVMs can be included in the flow. Each SVM can include a trained SVM. Each SVM can be based on a trained machine learning (ML) model to accomplish the classifying. The classifying can include evaluating the product of the scaled and vectorized signal features and a weight vector, with an added bias, as a positive result or a negative result. The positive result and the negative result can each indicate a classification, a classification/not classification, and so on. The result can include a value greater than zero (positive) or a value less than zero (negative). Progression from one SVM to another SVM can be based on a positive value or outcome. In embodiments, progression to an additional stage can be based on a binary classification outcome at a current stage. The binary outcome can include the positive or negative outcome, a “yes” or “no,” etc. In embodiments, the binary classification outcome can include a maybe/no decision.

The binary outcome determined by each SVM can include a positive or negative classification. Different actions such as further processing can be dependent on the classification. In some instances, a first classification outcome can finalize the classifying. In the illustration 600, the positive outcome of SVM A6 can determine a final outcome of a classification 670. A negative outcome of SVM A6 can also determine a final outcome of a classification 670. For the other SVMs A1 through A5, further processing can be based on a positive outcome. In some embodiments, a negative classification outcome can engage an additional single-feature support vector machine. Thus, the outcome of SVM A1 can engage SVM A2, the outcome of SVM A2 can engage SVM A3, and so on. The engagement of SVMs can proceed until a final classification can be determined.

Returning to the decision whether a saturation threshold has been exceeded or not, one or more other SVMs can be enabled for classifying the signal features. Further embodiments include processing the signal features using a combined-feature support vector machine. In the illustration 600, the combined-feature SVM can include SVM B 650. The processing using the combined-feature SVM can be enabled when the saturation threshold has been exceeded. The processing of the signal features can be accomplished using raw IR sensor data. The raw IR sensor data can include a peak amplitude included in a region of interest within the sensor data. The combined feature SVM can determine a classification based on the signal features. The classification can indicate a first type or class of IR flash event. The classification can indicate a second type or class of IR event. The first classification can be a gunshot flash classification, and the second classification can be a non-gunshot classification. The gunshot flash classification can be associated with a long gun, a handgun, and so on. The non-gunshot classification can be associated with a lightning flash, fireworks, etc.

Returning to the evaluating a peak amplitude 620, the weak signal threshold can be exceeded (yes) or not exceeded (no). Further embodiments include processing the signal features using a combined-feature support vector machine. In the flow, the combined-feature SVM can include SVM C 660. The processing using the combined-feature SVM can be enabled when the weak signal threshold has been exceeded. The processing of the signal features can be accomplished using filtered IR sensor data. The filtered IR sensor data can include a peak amplitude included in a region of interest within the sensor data. The combined feature SVM can determine a classification based on the signal features. The classification can indicate a first type or class of IR flash event. The classification can indicate a second type or class of IR event. The first classification can be a gunshot flash classification, and the second classification can be a non-gunshot classification. The gunshot flash classification can be associated with a long gun, a handgun, and so on. The non-gunshot classification can be associated with a lightning flash, fireworks, etc.

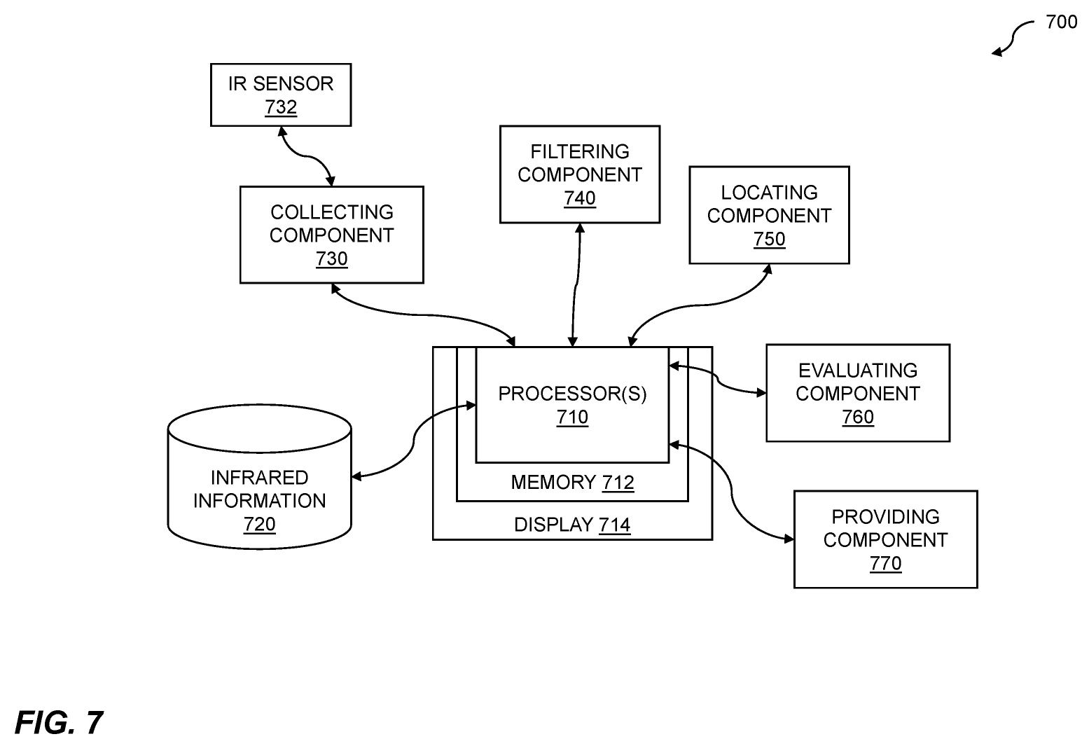

FIG. 7 is a system diagram for gunshot classification using filtered and raw data. The system 700 can include one or more processors 710 coupled to a memory 712 which stores instructions. The system 700 can include a display 714 coupled to the one or more processors 710 for displaying data, prompts, sensor information, intermediate steps, instructions, and so on. In embodiments, one or more processors 710 are coupled to the memory 712 where the one or more processors, when executing the instructions which are stored, are configured to: collect infrared (IR) information using one or more infrared sensors, wherein the infrared information is collected using infrared band sensing, and wherein the infrared information provides raw information; filter the raw information, wherein the filtering removes one or more noise sources from the raw information, and wherein the filtering produces filtered information; locate a first region of interest, based on the filtered information, wherein the first region of interest includes a first peak amplitude; evaluate the first peak amplitude against one or more thresholds, wherein the evaluating determines a classifier case; and provide a gunshot classification, wherein the gunshot classification is based on output from a classifier selected by the classifier case.

The system 700 includes a collecting component 730 . The collecting component 730 includes functions and instructions for collecting infrared (IR) information 720 using one or more infrared sensors 732 , wherein the infrared information is collected using infrared band sensing, and wherein the infrared information provides raw information. As the one or more infrared sensors detect light and gunshot residue events from a gunshot, the infrared information can be collected and forwarded for processing. The differences between the data collected from each of the one or more infrared sensors during the same event can be used in calculating the location and distance of the gunshot origin, as well as in classifying the event. The infrared information can be collected using infrared band sensing. The infrared (IR) information can include near-IR (NIR) information. The infrared sensor can sense one or more infrared bands, such as far-infrared (FIR) band light with wavelengths between 50-1000□m; a mid-infrared (MIR) band light with wavelengths between 3-50□m; and so on. The IR sensor can sense near-infrared (NIR) band light with wavelengths between 0.76-3□m. The infrared information provides raw information. The infrared information collected by the one or more infrared sensors can be stored “as is,” without any filtering applied to the data stream as it is captured by the one or more infrared sensors.

The system 700 includes a filtering component 740. The filtering component 740 includes functions and instructions for filtering the raw information, wherein the filtering removes one or more noise sources from the raw information, and wherein the filtering produces filtered information. The filtering of raw infrared sensor information can include bandpass filtering, which accepts specific wavelength ranges that can include both visible and infrared light; edge pass filtering, which can be used to focus on various ranges of the infrared spectrum; interference filters, which can be used to select specific wavelengths while preventing others; neutral density filters, which can reduce the intensity of visible and infrared light waves without favoring a particular wavelength; and so on. In embodiments, the filtering comprises sunlight filtering. In embodiments, the sunlight filtering removes sunlight glints. In embodiments, the sunlight filtering is performed using an FIR filter. In embodiments, the filtering comprises light white noise filtering. In embodiments, the light white noise filtering enables small caliber muzzle flash detection. In embodiments, the light white noise filtering is performed using a minimax filter. The filtering produces filtered information. The raw data streams from the one or more infrared sensors can be processed by one or more filters and the resulting filtered data streams can be stored for further analysis. Time stamps can be associated with the raw and filtered data streams from each IR sensor for comparison and analysis purposes.

The system 700 includes a locating component 750. The locating component 750 includes functions and instructions for locating a first region of interest, based on the filtered information, wherein the first region of interest includes a first peak amplitude. A first region of interest within the filtered IR information can be associated with an IR event that can include a gunshot event. The region of interest can be associated with changes to the IR information, where the changes can include abrupt changes. The first region of interest can be associated with a start and stop time stamp. The first region of interest can include a first peak amplitude. The peaks can include absolute peaks or relative peaks in the IR information. The peak amplitudes can include positive peaks and negative peaks. A given region of interest can include multiple peaks, where the multiple peaks can include one or more positive peaks and one or more negative peaks.

In some examples, the locating component 750 can extract at least one feature from infrared data. The locating component 750 can use the extracted feature in any relevant subcomponents (e.g., a machine learning model, classifier, or solver). The feature can include a signal shape associated with an amplitude peak detected in the signal, e.g., a positive peak, or a negative peak. The feature can include time domain features such as slopes between peaks, ratios of peaks, squared values of the signal features, or time delays, e.g., between an infrared peak and an acoustic peak. In some cases, the feature can include one or more earth mover distances, e.g., to each of two class-average acoustic or IR waveforms. In some embodiments, a frequency domain feature can include a Fast Fourier Transform of samples around an IR or acoustic peak, logarithms of a Fast Fourier Transform of samples around an IR or acoustic peak, and so on. In some cases, more than two earth mover distance measures are used. One or more class-averaged waveforms, e.g., one for several different weapons, can be used—e.g., to classify one or more gunshots as belonging to one or more different weapons. In some cases, a feature can include data indicating energy or entropy measures—e.g., from before, during, or after a peak in amplitude. In some cases, the locating component 750 can use a curvature measure—e.g., to distinguish between detectable elements, such as shocks from muzzles.

The system 700 includes an evaluating component 760. The evaluating component 760 includes functions and instructions for evaluating the first peak amplitude against one or more thresholds, wherein the evaluating determines a classifier case. A high threshold can comprise 97% of full scale. A low threshold can comprise 10% of full scale. The first peak amplitude can be compared to the high and low thresholds and can be used to assign the peak amplitude to a classifier case or category. The evaluating can determine a classifier case. A classifier case can be used to categorize the first peak amplitude. The classifier case can be used to determine whether a raw or filtered data stream from the one or more infrared sensors can be used to analyze the first peak amplitude. A first peak amplitude that exceeds the high threshold can be classified as a saturated signal case. A first peak amplitude that falls between the high threshold percentage and the low threshold percentage can be classified as an unsaturated signal case. A first peak amplitude that is lower than the low threshold percentage can be classified as a weak signal case.

The evaluating can include locating a second region of interest, based on the raw information, wherein the second region of interest includes a second peak amplitude. IR sensors can have limitations in their response time. Sensor design, materials used, signal noise, processing delays, hardware, and so on can introduce delays in the sensor data stream. Signal processing delays can be compensated for using predictive algorithms, delay compensation filters, time-stamping, data buffering, adaptive algorithms, and so on. Analyses of the raw data from the one or more IR sensors can result in locating a second region of interest, including a second peak amplitude. The second region of interest can be related to the same gunshot event, but with different start and stop time stamps, based on the data compensation for signal processing delays. The evaluating can be redone based on the second region of interest including the second peak amplitude.

The system 700 includes a providing component 770. The providing component 770 includes functions and instructions for providing a gunshot classification, wherein the gunshot classification is based on output from a classifier selected by the classifier case. The classifier case can be used to determine whether raw or filtered data can be used to analyze the first and/or second region of interest. The classifier case can be used to select how the infrared data is analyzed, what signal features to extract, what domain features to process, and so on. The extracting of signal features from the infrared information enables information analysis and classification for IR flash events. The classification can be a binary determination of whether the infrared data indicates a gunshot event or a non-gunshot event. In some cases, additional gunshot event classifications can be associated with a long gun, a handgun, and so on. The non-gunshot classification can be associated with a lightning flash, fireworks, etc.

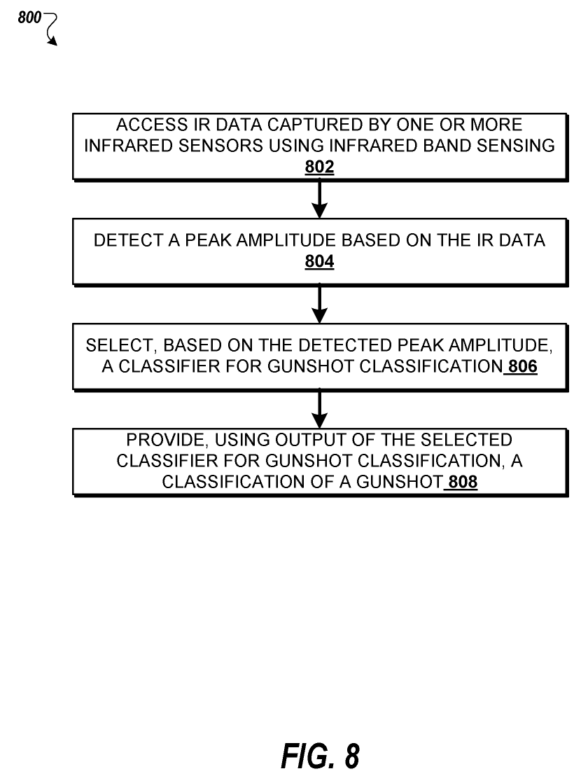

FIG. 8 is a flow diagram of a process 800 for gunshot classification. For example, the process 800 can be used by the system 700 shown in FIG. 7, e.g., a gunshot sensor.

The process 800 includes accessing IR data captured by one or more infrared sensors using infrared band sensing (802). For example, the collecting component 730 can collect IR data from the one or more infrared sensors 732.

The process 800 includes detecting a peak amplitude based on the IR data (804). For example, the locating component 750 shown in FIG. 7 can locate a first region of interest that includes a first peak amplitude. This first region can indicate an IR event, such as a gunshot.

The process 800 includes selecting, based on the detected peak amplitude, a classifier for gunshot classification (806). For example, the evaluating component 760 can select, using one or more thresholds, a classifier for gunshot classification based on a determined classifier case—e.g., a threshold can include various percentages of a detector sensing range, such as 97% or 10%, among others.

In some cases, the process 800 can include determining a comparison between the peak amplitude and one or more amplitude thresholds. Selecting the classifier can include using the comparison to determine which classifier of one or more maintained classifiers to select. For example, if a peak amplitude is greater than or equal to a percentage of a maximum detector sensing range, such as 97%, the evaluating component 760 can select a classifier for a saturated case.

In some cases, the process 800 can include determining a saturation level of one or more infrared sensors, e.g., based on a detected peak amplitude. The saturation level can be determined using one or more amplitude thresholds. Selecting the classifier for gunshot classification from the one or more maintained classifiers can include selecting, based on a determined saturation level, between two or more classifiers. The two or more classifiers can include different processing pipelines. For example, a first classifier of the one or more maintained classifiers can use a first processing pipeline that is different than a second processing pipeline used by a second classifier of the one or more maintained classifiers. The first processing pipeline can include processing by multiple machine learning models, such as a set of support vector machines (SVMs), and the second processing pipeline can include processing by a single machine learning model, such as a single SVM, or a set of multiple machine learning models that includes at least one model different from the multiple models of the first processing pipeline. The first processing pipeline can include processing by a first model, such as an SVM, with a first set of training parameters and the second processing pipeline can include processing by a second machine learning model with a second set of training parameters different than the first set of training parameters. The training parameters can result from one or more training operations of a model, such as the training of the SVMs, e.g., as shown and discussed in reference to FIG. 5. Training parameters can include one or more weights or biases.

The process 800 includes providing, using output of the selected classifier for gunshot classification, a classification of a gunshot (808). For example, data indicating a gunshot can be provided to the selected classifier, such as the classifiers 360 shown in FIG. 3. In some cases, a classifier includes one or more machine learning models, such as support vector machines (SVMs). An SVM approach is shown in FIG. 6. Output from a classifier can be provided to one or more devices communicably connected to a detection system, such as personal computers, mobile communication devices, or other devices that can send and receive data over a wired or wireless network.

In some cases, the process 800 includes generating filtered IR data. For example, the filtering component 740 can be used to filter raw IR data captured by one or more IR sensors, such as the IR sensor 732. IR data can be filtered to remove one or more likely noise sources from the IR data. In some cases, the locating component 750 can detect a peak amplitude in a filtered version of IR data. IR data can be filtered using at least one of a bandpass filter, an edge pass filter, an inference filter, or a neutral density filter. In some cases, filtering can include filtering out IR data that likely indicates sunlight, such as sunlight glints. Filtering can use a far-infrared (FIR) filter, e.g., for filtering likely sunlight.

In some cases, filtering can include using a light white noise filtering technique. Filtering IR data using light white noise filtering can include filtering the IR data captured by the one or more infrared sensors using a minimax filter. Light white noise filtering can help detect smaller caliber gunshots which may be less detectable than larger caliber gunshots without such filtering because their generated IR data is more likely to be obfuscated by background IR data from various environmental IR emitters. A classifier, such as one or more of the classifiers 360, can detect a gunshot classification using input data that includes one or more features of filtered IR data after light white noise filtering of IR data. A muzzle flash can be detected based on the output of the classifier. The muzzle flash detected can be that of a handgun or other similar caliber gun. A system can provide an indication of the muzzle flash detection, e.g., using one or more communicably connected devices.

The order of operations in the process 800 described above is illustrative only, and gunshot classification can be performed in different orders. In some implementations, the process 800 can include additional operations, fewer operations, or some of the operations can be divided into multiple operations.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrent. In some examples, two operations can execute substantially concurrently when they have the same start time, same end time, or both.

In this specification, the term likely can mean that there is a likelihood that something might occur and that the likelihood satisfies a likelihood threshold. For instance, when determining that an object is likely depicted in an image, a system would determine a likelihood that the object is depicted in the image. The system would then determine whether the likelihood satisfies, e.g., is greater than or equal to, a likelihood threshold by comparing the two values. If so, the system determines that the object is likely depicted in the image. If not, the system determines that the object is not likely depicted in the image.

A system for detecting gunshots can be implemented as computer programs on one or more computers in one or more locations, in which the systems, components, and techniques described in this specification are implemented. Devices communicably connected to the system can include personal computers, mobile communication devices, and other devices that can send and receive data over a network. The network (not shown), such as a local area network (“LAN”), wide area network (“WAN”), the Internet, or a combination thereof, can connect the devices and the system. The devices can use a single computer or multiple computers operating in conjunction with one another, including, for example, a set of remote computers deployed as a cloud computing service.

A system for detecting gunshots can include several different functional components, including, e.g., the filtering element 330, the locating element 340, the classifiers 360, the evaluating element 350, and the providing element 380. Any one or more of the components can include one or more data processing apparatuses, can be implemented in code, or a combination of both. For instance, each of the components can include one or more data processors and instructions that cause the one or more data processors to perform the operations discussed in this specification.

The various functional components of a system for detecting gunshots, such as the system 700 of FIG. 7, or the system shown in FIG. 3, can be installed on one or more computers as separate functional components or as different modules of the same functional component. For example, the components of the system 700, such as the collecting component 730, the filtering component 740, the locating component 750, the evaluating component 760, and the providing component 770, can be implemented as computer programs installed on one or more computers in one or more locations that are coupled to each through a network. In cloud-based systems for example, these components can be implemented by individual computing nodes of a distributed computing system.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non transitory program carrier for execution by, or to control the operation of, a data processing apparatus. Alternatively or in addition, the program instructions can be encoded on an artificially generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application specific integrated circuit (“ASIC”).

Computers suitable for the execution of a computer program include, by way of example, general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a client device, e.g., for purposes of displaying data to and receiving user input from a client device, which acts as a client. Data generated at the client device, e.g., a result of user interaction with the client device, can be received from the client device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A method comprising:
accessing infrared (IR) data captured by one or more infrared sensors using infrared band sensing;
detecting a peak amplitude using the IR data;
selecting, from one or more maintained classifiers and using the detected peak amplitude, a classifier for gunshot classification; and
providing, using output of the selected classifier for gunshot classification, a classification of a gunshot.

2. The method of claim 1, comprising:
determining, using one or more amplitude thresholds, a comparison between the peak amplitude and the one or more amplitude thresholds, wherein selecting the classifier for gunshot classification from the one or more maintained classifiers comprises:
selecting the classifier for gunshot classification using the comparison between the peak amplitude and the one or more amplitude thresholds.

3. The method of claim 1, comprising:
determining a saturation level of the one or more infrared sensors using the detected peak amplitude, wherein selecting the classifier for gunshot classification from the one or more maintained classifiers comprises:
selecting, using the determined saturation level, a first classifier of the one or more maintained classifiers that classifies a gunshot using a first processing pipeline different than a second processing pipeline used by a second classifier of the one or more maintained classifiers.

4. The method of claim 3, wherein the first processing pipeline includes processing by one or more first machine learning models and the second processing pipeline includes processing by one or more second machine learning models, at least some models in the one or more first machine learning models not included in the one or more second machine learning models.

5. The method of claim 3, wherein the first processing pipeline includes processing by a first machine learning model with a first set of training parameters and the second processing pipeline includes processing by a second, different machine learning model with a second, different set of training parameters different than the first set of training parameters.

6. The method of claim 3, wherein the first processing pipeline includes processing by two or more machine learning models and the second processing pipeline includes processing by a single machine learning model.

7. The method of claim 1, comprising:
generating filtered IR data by filtering the IR data captured by the one or more infrared sensors to remove one or more likely noise sources from the IR data, wherein detecting the peak amplitude using the IR data comprises:
detecting the peak amplitude in the filtered IR data.

8. The method of claim 7, wherein generating the filtered IR data comprises:
filtering the IR data using at least one of a bandpass filter, an edge pass filter, an inference filter, or a neutral density filter.

9. The method of claim 7, wherein the filtering comprises filtering out IR data that likely indicates sunlight.

10. The method of claim 9, wherein filtering out the IR data that indicates likely sunlight comprises:
filtering the IR data using a far-infrared (FIR) filter.

11. The method of claim 7, wherein generating the filtered IR data comprises:
filtering the IR data using light white noise filtering.

12. The method of claim 11, comprising:
providing, to the selected classifier for gunshot classification, one or more features of the filtered IR data after light white noise filtering of the IR data; and
detecting, using the output of the selected classifier, a muzzle flash, wherein providing the classification of the gunshot comprises:
providing an indication of the muzzle flash detection.

13. The method of claim 11, wherein filtering the IR data using light white noise filtering comprises:
filtering the IR data captured by the one or more infrared sensors using a minimax filter.

14. The method of claim 1, comprising:
detecting the peak amplitude in the IR data captured by the one or more infrared sensors using infrared band sensing.

15. A system comprising one or more computers and one or more storage devices on which are stored instructions that are operable, when executed by the one or more computers, to cause the one or more computers to perform operations comprising:
accessing infrared (IR) data captured by one or more infrared sensors using infrared band sensing;
detecting a peak amplitude using the IR data;
selecting, from one or more maintained classifiers and using the detected peak amplitude, a classifier for gunshot classification; and
providing, using output of the selected classifier for gunshot classification, a classification of a gunshot.

16. The system of claim 15, wherein the operations comprise:
determining, using one or more amplitude thresholds, a comparison between the peak amplitude and the one or more amplitude thresholds, wherein selecting the classifier for gunshot classification from the one or more maintained classifiers comprises:
selecting the classifier for gunshot classification using the comparison between the peak amplitude and the one or more amplitude thresholds.

17. The system of claim 15, wherein the operations comprise:
determining a saturation level of the one or more infrared sensors using the detected peak amplitude, wherein selecting the classifier for gunshot classification from the one or more maintained classifiers comprises:
selecting, using the determined saturation level, a first classifier of the one or more maintained classifiers that classifies a gunshot using a first processing pipeline different than a second processing pipeline used by a second classifier of the one or more maintained classifiers.

18. The system of claim 17, wherein the first processing pipeline includes processing by one or more first machine learning models and the second processing pipeline includes processing by one or more second machine learning models, at least some models in the one or more first machine learning models not included in the one or more second machine learning models.

19. The system of claim 17, wherein the first processing pipeline includes processing by a first machine learning model with a first set of training parameters and the second processing pipeline includes processing by a second, different machine learning model with a second, different set of training parameters different than the first set of training parameters.

20. One or more computer storage media encoded with instructions that, when executed by one or more computers, cause the one or more computers to perform operations comprising:
accessing infrared (IR) data captured by one or more infrared sensors using infrared band sensing;
detecting a peak amplitude using the IR data;
selecting, from one or more maintained classifiers and using the detected peak amplitude, a classifier for gunshot classification; and
providing, using output of the selected classifier for gunshot classification, a classification of a gunshot.
